(19) United States
(12) Patent Application Publication
(10) Pub. No.: US 2019/0390901 A1
(43) Pub. Date: Dec. 26, 2019

(54) PURIFICATION PROCESS FOR PRODUCTION OF ULTRA HIGH PURITY CARBON MONOXIDE

(71) Applicant: Linde Aktiengesellschaft, Munich (DE)

(72) Inventor: David Milner, Long Valley, NJ (US)

(73) Assignee: Linde Aktiengesellschaft, Munich (DE)

(21) Appl. No.: 16/475,405

(22) PCT Filed: Dec. 8, 2017
(86) PCT No.: PCT/US2017/065327

§ 371 Date: Jul. 11, 2019

Related U.S. Application Data
(60) Provisional application No. 62/433,274, filed on Dec. 13, 2016.

(51) Int. Cl. F25J 3/02; C01B 32/40

(52) U.S. Cl. CPC F25J 3/0261; F25J 3/0223; C25B 1/00; F25J 3/0266; C01B 32/40; F25J 3/0252

(57) ABSTRACT

Methods and apparatus for the production of ultra high purity carbon monoxide having a carbon dioxide content of 0.1 ppm or less is disclosed. Carbon dioxide is removed from a product stream using a reversing heat exchanger to freeze the carbon dioxide out of the product stream, This provides the ultra high purity carbon monoxide product which meets the requirements of the electronic industry applications.

### CROSS REFERENCE TO RELATED APPLICATIONS

This application claims priority fror U.S. Provisional Application Ser. No. 62/433,274 filed on Dec. 13, 2016.

### FIELD OF THE INVENTION

The present invention relates to methods and apparatus for producing ultra high purity carbon monoxide (CO).

### BACKGROUND OF THE INVENTION

CO that has low levels of nitrogen may be produced from a carbon dioxide (CO₂) stream by electrolysis process. However, these production methods produce CO that still has up to 5,000 ppm CO₂ remaining in the product stream. Further, the CO product stream typically contains hydrogen (H₂) as an undesirable impurity. This amount of CO₂ and H₂ is unacceptable for use as electronic grade CO. Electronic grade CO is required to be of Ultra High Purity (UHP) having a CO2 and H₂ content of 0.1 ppm or less.

There remains a need in the art for improvements to the production of CO, particularly for use as an electronic grade gas.

### SUMMARY OF THE INVENTION

The invention provides methods and apparatus for the production of UHP CO having a CO₂ content of 0.1 ppm or less. This is achieved by treating the CO (which may be as much as 99.5% CO stream from the primary CO production process using a reversing heat exchanger to freeze the CO₂ out of the source stream.

The CO product produced by the method and apparatus of the invention contains 0.1 ppm or less of CO₂ and is therefore acceptable for use as an electronic grade CO product.

### BRIEF DESCRIPTION OF THE DRAWINGS

FIG. 1 is a schematic view of a process system for the production of UHP CO according to an embodiment of the invention.

FIG. 2 is a schematic view of a process system for the production of UHP CO according to another embodiment of the invention.

FIG. 3 is a schematic view of a process system for the production of UHP CO according to another embodiment of the invention.

### DETAILED DESCRIPTION OF THE INVENTION

The invention will be described with reference to the drawing figures.

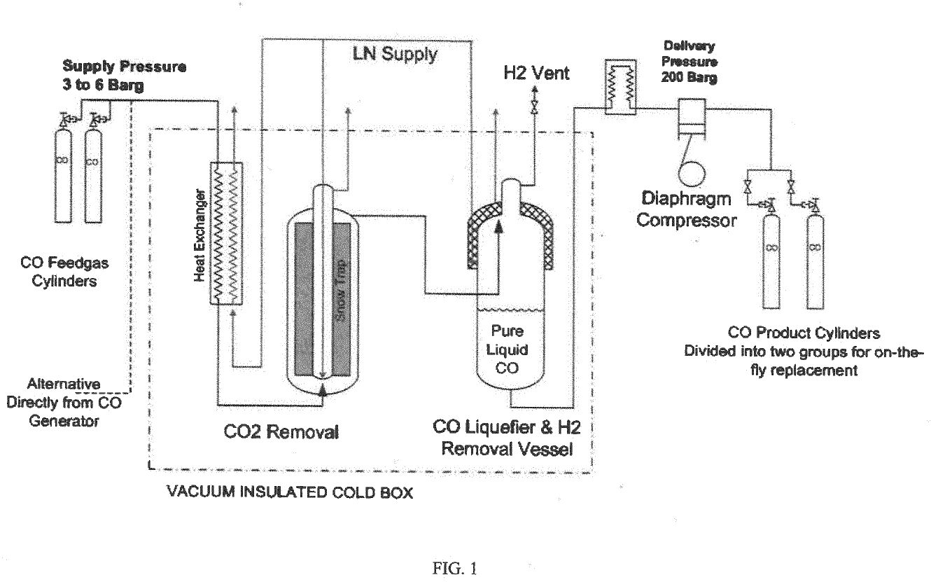

In FIG. 1, a source of CO to be purified may be provided to the system from either CO feed gas cylinders or directly from a CO generator. In either case, the supply pressure should be from 3 to 6 bar. By producing the product CO at a pressure of approximately 6 bar, it is possible to advantageously use a single stage compressor to fill product cylinders. The lower limit of production pressure is a function of the lowest practical liquid nitrogen pressure in order to be able to liquefy the product stream against this Liquid Nitrogen stream.

The CO to be purified is delivered to the system and enters CO₂ removal unit that includes a reversing heat exchanger and a snow trap. The CO₂ content of the CO source gas is frozen out in the reversing heat exchanger. Any CO₂ that does not adhere to the walls of the heat exchanger and is transported by the process flow as crystals or snow is then captured in the snow trap. It is critical that the snow trap be operated as close to the process liquefaction temperature as possible without allowing liquefaction to occur. Liquefaction in the snow separator could cause the product purity to decrease if the CO₂ particles become dissolved or suspended in the liquid product stream. Preferably the reversing heat exchanger, the snow trap and the CO liquefier and H₂ removal vessel are placed in a vacuum insulated cold box.

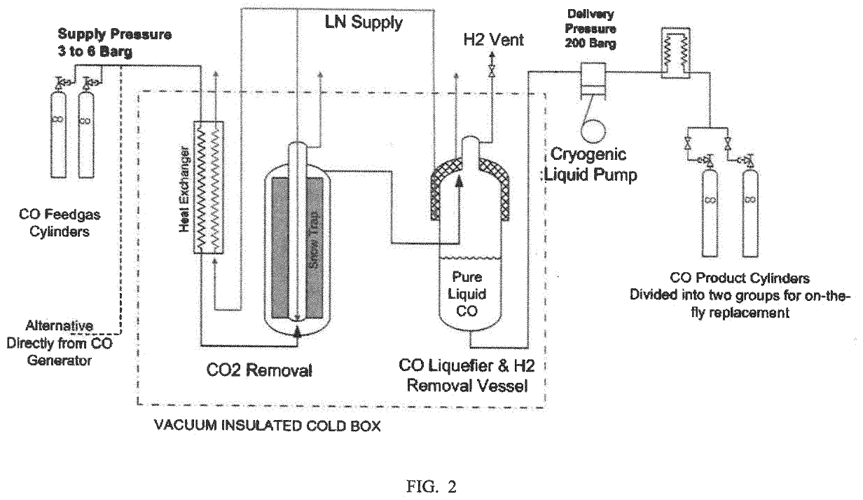

Periodically the snow trap and the heat exchanger are regenerated using some combination of heat, vacuum and a suitable purge gas such as Helium or Argon that is not considered a contaminant in the process gas by virtue of its subsequent application. At the end of the regeneration cycle it may be advantageous to sweep the system with pure CO product gas before beginning the next cool down and freeze out cycle. A source of liquid nitrogen (LN) provides the cold needed for the freezing of the CO₂. Once the CO2 has been removed from the CO source gas, the CO gas is delivered to a CO liquefier and H₂ removal vessel. In this vessel, the CO is cooled to liquid temperatures and H2 is released and vented from the system. The liquid CO can then be compressed and delivered to CO product cylinders for distribution to customers. As shown in FIG. 1, the CO is compressed using a diaphragm compressor to achieve product cylinder pressure of about 200 Bar. FIG. 2 shows a similar system, the only difference being that the CO is compressed using a cryogenic liquid pump.

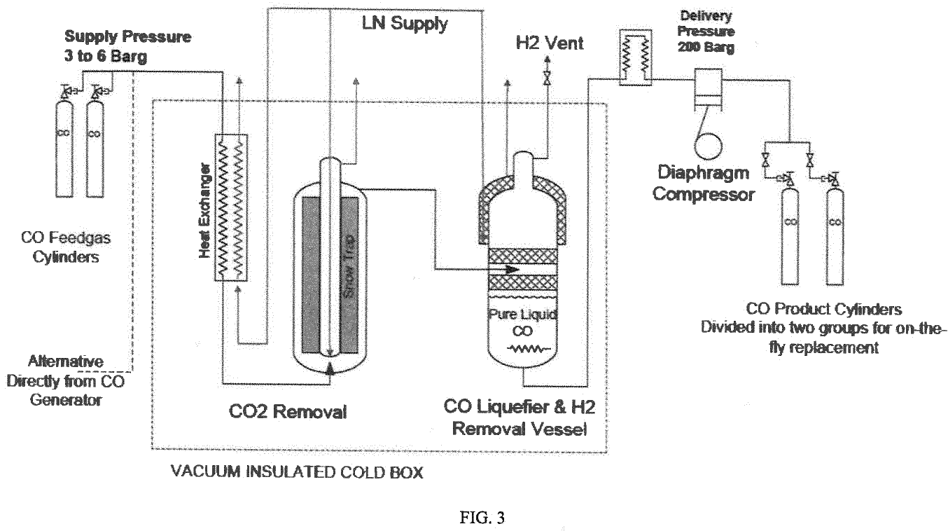

In another embodiment, the CO liquefier and H2 removal vessel may contain internals improving the condensation and/or the separation of the different phases. In a further preferred embodiment, the position of the CO gas inlet can be positioned between the internals. FIG. 3 shows a similar system as FIG. 1, the only difference being that the CO liquefier and H₂ removal vessel contains internals.

In a preferred method of operating the described invention, a gas flow of 0.1 Nm3/hr up to 50 Nm3/hr can be purified. More preferably, the gas flow is between 5 Nm3/hr and 10 Nm3/hr or between 6 to 8 Nm3/hr.

The cold needed for freezing of the CO₂ as well as liquefying the CO is provided by a source of liquid nitrogen (LN). The nitrogen passes through the system and can be treated and recycled or released to the atmosphere. Any waste N₂ or H₂ released from the system will be low in CO₂ or CO content.

To have an economically effective process the working pressures and working temperatures are preferably based on the available specifications of the liquid nitrogen. Inside of the vacuum insulated cold box the gas stream is cooled from around ambient temperature (300 K) to around 100 K (+/−5 degree).

### EXAMPLE

CO is provided from fee gas cylinders, wherein two banks of cylinders with auto changeover are set up. The CO feed gas might have the following typical specifications:

| CO | 99.8% | | CO₂ | 2,000 | ppm |
|---|---|---|---|---|---|
| N₂ | 4 | ppm | O₂ | 0.05 | ppm |
| H₂ | 40 | ppm | H₂O | <0.1 | ppb |
| CxHy | <0.1 | ppb | | | |

Following treatment of the CO feed gas using the system of the invention, the product CO gas meets or exceeds the following specifications:

| CO | 99.9999% | | CO₂ | 0.1 | ppm |
|---|---|---|---|---|---|
| N₂ | 6 | ppm | O₂ | 0.1 | ppm |
| H₂ | 0.1 | ppm | H₂O | 0.004 | ppb |
| CxHy | 0.3 | ppb | | | |

The invention as described above provides a number of advantages. In particular, the invention provides a cost-effective method for purification of CO to obtain UHP CO needed by the electronics industry. The production of UHP CO by the method of the invention will be less expensive both in capital and operation costs as compared to prior art methods that were based on distillation technology.

An additional advantage of the invention is, that in the reversing heat exchanger also other impurities are removed from the CO source gas. The amount of carbonyl compounds, is reduced to a level below common detection levels. This is a special advantage for Iron Pentacarbonyl (Fe(CO)₄) or Nickel Tetracarbonyl (Ni(CO)₅), which are formed if CO is getting in contact with stainless steel, By careful material selection downstream of the cryogenic purification process, a CO gas with very low levels of carbonyl compound can be produced.

It is anticipated that other embodiments and variations of the present invention will become readily apparent to the skilled artisan in the light of the foregoing description, and it is intended that such embodiments and variations likewise be included within the scope of the invention as set out in the appended claims.

What is claimed:

1. A method of producing ultra high purity carbon monoxide characterized in that a carbon monoxide stream is cooled in a reversing heat exchanger for freezing out removing carbon dioxide and whereas the gas stream is afterwards directed to a snow trap for removing solid particles and Whereas the gas stream is after the snow trap direct to a liquefier and hydrogen removal vessel, wherein the carbon monoxide is liquefied and hydrogen remains in a gaseous state and is separated.

2. The method of producing ultra high purity carbon monoxide according to claim 1, characterized in that as cooling agent in the reversing heat exchanger, in the snow trap and in the liquefier and hydrogen removal vessel liquid nitrogen is used.

3. The method of producing ultra high purity carbon monoxide according to claim 1 wherein the liquid ultra high purity carbon monoxide is compressed by a diaphragm compressor or a cryogenic liquid pump and stored in gas cylinders.

4. The method of producing ultra high purity carbon monoxide according to claim 1, characterized in that the content of carbon dioxide and hydrogen in the ultra high purity carbon monoxide is 0.1 ppm or less.

5. An apparatus for producing ultra high purity carbon monoxide characterized in that the apparatus comprises a heat exchanger, which is connected to a snow trap, which is also connected to a liquefier and hydrogen removal vessel.

6. The apparatus for producing ultra high purity carbon monoxide according to claim 5, characterized in that the heat exchanger, the snow trap, the liquefier and hydrogen removal vessel and the respective connecting lines are placed in vacuum insulated cold box.

7. The apparatus for producing ultra high purity carbon monoxide according to claim 5, characterized in that the liquefier and hydrogen removal vessel contains inserts.

8. The apparatus for producing ultra high purity carbon monoxide according to claim 5, characterized in that the purified carbon monoxide stream is compressed by a diaphragm compressor or a cryogenic liquid pump.
